(19) United States
(12) Patent Application Publication
(10) Pub. No.: US 2012/0131569 A1
(43) Pub. Date: May 24, 2012

(54) AUTOMATED SOLARIS CONTAINER CREATION

(75) Inventors: Mark Josepher, Syosset, NY (US); Keith R. Warno, Mastic Beach, NY (US)

(73) Assignee: COMPUTER ASSOCIATES THINK, INC., Islandia, NY (US)

(21) Appl. No.: 12/950,503

(22) Filed: Nov. 19, 2010

(51) Int. Cl. G06F 9/445

(52) U.S. Cl. 717/174

(57) ABSTRACT

The inventive method comprises obtaining predetermined parameters, associating these parameters with a creation script file, executing the script file to install the complete runtime environment according to the predetermined parameters, and publishing notification of the installation of the complete runtime environment on the machine. In one aspect, executing the script is performing an autoboot. In one aspect, obtaining predetermined parameters is performed using a GUI. In one aspect, the complete runtime environment is a Solaris container. In one aspect, the predetermined parameters comprise at least one of zone name, IP address, Solaris version, number of CPUs, amount of memory and number of processors. The method can also comprise determining whether the runtime environment exists on the machine and if the runtime environment exists, reinstalling the runtime environment on the machine. The method can also comprise notifying a system operator if the runtime environment exists on the machine.

### FIELD

The present disclosure relates generally to Solaris operating systems and, more particularly, to automating the creation of Solaris containers.

### BACKGROUND

Solaris is a Unix-based operating environment that was initially released in the early 1980s. This operating environment typically includes a Solaris container which has a resource manager and zones which perform software partitioning. The zones provide virtual mapping from applications to platform resources. Numerous versions of the Solaris system have been released since the its initial release. As with almost all software, each Solaris version has its own quirks and idiosyncrasies. Among other things, each version interacts differently with the application programs Solaris runs. Accordingly, when debugging application software, it becomes necessary to recreate the relevant Solaris container version so that appropriate testing can be performed.

Generally Solaris machines include a large number of resources. Typically a Solaris machine is sliced or divided into Solaris zones which associate hardware and software. These zones enable one physical machine to operate with distinct hardware, both old and new. The zones also allow different versions of the Solaris operating system, e.g., version 8, version 9, etc., to be run on a single machine or server. Thus both older and newer Solaris versions can execute with new hardware on the same server. Moreover, each user can have his or her “contained little world” with his/her own version of Solaris.

The installation of Solaris containers is performed manually, using a very time consuming process which is prone to installation errors. It is difficult to create Solaris containers because there are many parameters that must be established. Further, it is quite challenging to create a duplicate or mirror Solaris container that can be used to test and/or debug applications run in the Solaris container. There is a need for an automated technique to create a specific Solaris container with the desired parameters and Solaris version as a duplicate of an existing container, including its parameters, etc.

### BRIEF SUMMARY

A system and method for creating a complete runtime environment is presented. The inventive technique includes the ability to perform unattended installs of Solaris containers. This inventive method comprises obtaining predetermined parameters, associating, on a processor, the predetermined parameters with a creation script file, executing, on the processor, the creation script file to install the complete runtime environment according to the predetermined parameters, and publishing, on a display, notification of the installation of the complete runtime environment on the machine.

In one aspect, executing the script is performing an autoboot. In one aspect, obtaining predetermined parameters is performed using a graphical user interface (GUI). In one aspect, the complete runtime environment is a Solaris container. In one aspect, the predetermined parameters comprise at least one of zone name, IP address, Solaris version, number of CPUs, amount of memory and number of processors. In one aspect, the method further comprises determining whether the runtime environment exists on the machine and if the runtime environment exists, reinstalling it on the machine. In one aspect, the method further comprises notifying a system operator if the runtime environment exists on the machine.

The inventive system for creating a complete runtime environment comprises a processor on the machine, a display device accessible by the machine, and a module operable to obtain predetermined parameters, associate the predetermined parameters with a creation script file, execute the creation script file to install the complete runtime environment according to the predetermined parameters, and publish, on the display device, notification of the installation of the complete runtime environment on the machine.

In one aspect, the complete runtime environment of the system is a Solaris container. In one aspect, the predetermined parameters comprise at least one of zone name, IPaddress, Solaris version, number of CPUs, amount of memory and number of processors. In one aspect, the module employs a GUI to obtain the predetermined parameters. In one aspect, the module is further operable to determine whether the runtime environment exists on the machine, and to reinstall the runtime environment on the machine when the runtime environment exists. In one aspect, the module is further operable to notify a system operator when the runtime environment exists.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a schematic diagram of one embodiment of the present invention.

FIG. 2 is a flow diagram of one embodiment of the present invention.

FIG. 3 is a flow diagram of another embodiment of the present invention.

### DETAILED DESCRIPTION

An inventive system and method for creating a complete runtime environment on a machine is presented. This novel technique includes constructing a Solaris container according to specific criteria that can be obtained from another Solaris container. The automation of the Solaris Zone-construction process based on predetermined parameters is thus enabled.

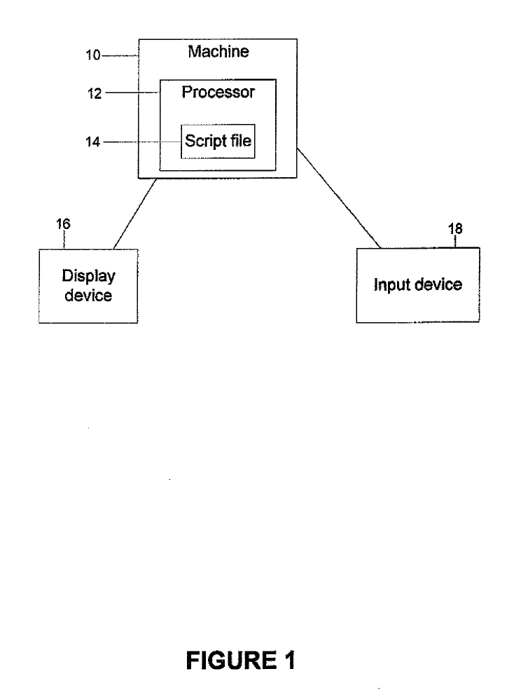

FIG. 1 is a schematic diagram of the inventive system. As shown in FIG. 1, the system includes a machine 10 having a processor 12, a script file 14, a display device 16, and an input device 18. The script file 14 can reside in the processor 12. The display device 16 and/or the input device 18 can be connected to the machine 10.

The display device 16 can be a monitor, a laptop computer, a mobile device or any device capable of displaying information. The input device 18 can be a keyboard, a mouse, software and hardware having graphical user interface capabilities, a mobile device having input capabilities or any device capable of inputting information. Software such as Labs-on-Demand can be used to provide users with the ability to input the parameters and/or additional information to the system.

Unlike a virtual machine, a machine executing Solaris containers does not have its own kernel. Thus, changes to Solaris affect the host machine.

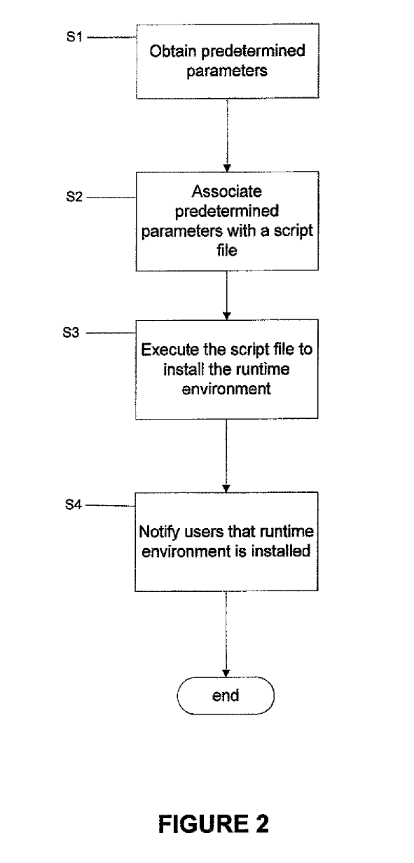

FIG. 2 is a flow diagram of the novel process in one embodiment of the invention. In step S1, predetermined parameters are obtained. These parameters enable creation of a runtime environment that mirrors or duplicates another such environment. The parameters or attributes can be obtained using any input device. In one embodiment, the parameters are input using a GUI such as Labs-on-Demand. The attributes necessary for the script can be gathered from the GUI when a user asks to create or re-image a particular Solaris container.

In step S2, the predetermined parameters are associated with a creation script. In step S3, the creation script is executed on the processor 12 to install the runtime environment on a target machine 10. In step S4, notification is provided that the runtime environment is installed and available for use. After step S4, the process ends.

Thus, the creation script, e.g., a Solaris container creation script, performs all the necessary tasks to create and install the Solaris zone including the network setup for multiple zone configuration settings. Accordingly, the creation of Solaris containers is now performed automatically utilizing a GUI interface with the additional logic that allows support of older operating systems with newer hardware.

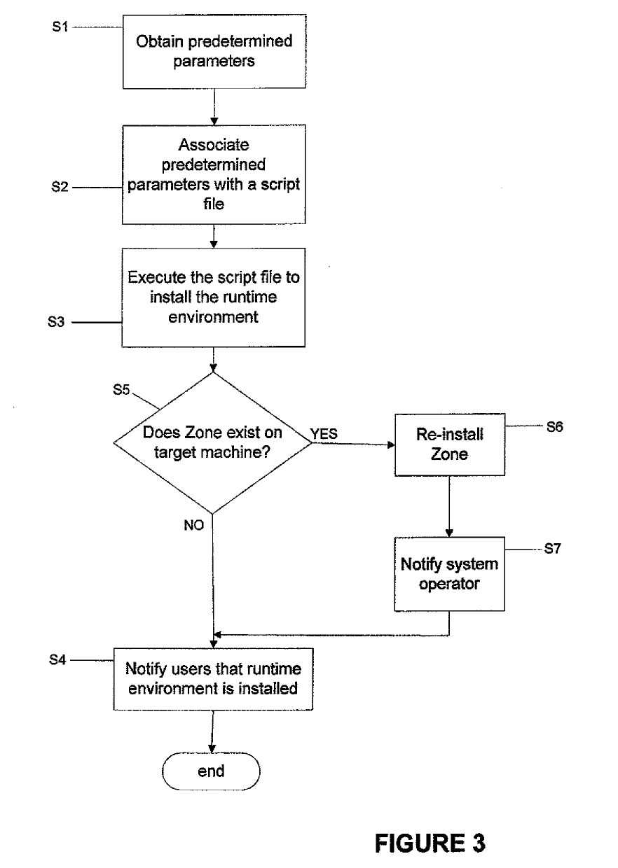

FIG. 3 is a flow diagram of the novel process in another embodiment of the invention. Steps S1-S4 are the same as in FIG. 2; description of these steps is not repeated. After step S3, in step S5, the creation script checks to see if zone already exists on the targeted machine. If the zone exists (S5=YES), in step S6 the zone is reinstalled by the creation script based on the predetermined parameters. In step S7, the creation script can notify the system operator that the zone exists. Step S7 is optional. In one embodiment (not shown), the process proceeds from step S6 to step S4 without performing step S7. After step S4, the process ends.

If the zone does not exist on the target machine (S5=NO), the process proceeds to step S4. After step S4, the process ends.

In one embodiment, arguments given to the creation script can include: zone number, IP address, Solaris ID, amount of memory, number of CPUs, number of processors, and/or amount of disk quota.

Advantageously, the invention eliminates the laborious task of manually creating and/or reinstalling Solaris containers. The process is automated, enabling it to be performed unattended. This allows system administrators and others who install runtime environments to concentrate on other important tasks.

Beneficially, the creation script is predictable so that a duplicate Solaris container having the same attributes as the original can be implemented on a target machine. This facilitates application testing and debugging without interfering with “live” systems.

Various aspects of the present disclosure may be embodied as a program, software, or computer instructions embodied or stored in a computer or machine usable or readable medium, which causes the computer or machine to perform the steps of the method when executed on the computer, processor, and/or machine. A program storage device readable by a machine, e.g., a computer readable medium, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The computer readable medium could be a computer readable storage medium or a computer readable signal medium. Regarding a computer readable storage medium, it may be, for example, a magnetic, optical, electronic, electromagnetic, infrared, or semiconductor system, apparatus, or device, or any suitable combination of the foregoing; however, the computer readable storage medium is not limited to these examples. Additional particular examples of the computer readable storage medium can include: a portable computer diskette, a hard disk, a magnetic storage device, a portable compact disc read-only memory (CD-ROM), a random access memory (RAM), a read-only memory (ROM), an erasable programmable read-only memory (EPROM or Flash memory), an electrical connection having one or more wires, an optical fiber, an optical storage device, or any appropriate combination of the foregoing; however, the computer readable storage medium is also not limited to these examples. Any tangible medium that can contain, or store a program for use by or in connection with an instruction execution system, apparatus, or device could be a computer readable storage medium.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

What is claimed is:

1. A method for creating a complete runtime environment on a machine, comprising steps of
obtaining predetermined parameters;
associating, using a processor, the predetermined parameters with a creation script file;
executing, using the processor, the creation script file to install the complete runtime environment according to the predetermined parameters; and
publishing, on a display, notification of the installation of the complete runtime environment on the machine.

2. The method according to claim 1, wherein the step of executing the creation script file is performing an autoboot.

3. The method according to claim 1, wherein the complete runtime environment is a Solaris container.

4. The method according to claim 3, wherein the predetermined parameters comprise at least one of zone name, IP address, Solaris version, number of CPUs, amount of memory and number of processors.

5. The method according to claim 1, wherein the step of obtaining is performed using a graphical user interface.

6. The method according to claim 1, further comprising steps of:
determining whether the runtime environment exists on the machine; and
reinstalling the runtime environment on the machine when the runtime environment exists.

7. The method according to claim 6, further comprising a step of notifying a system operator when the runtime environment exists.

8. A system for creating a complete runtime environment on a machine, comprising:
a processor on the machine;
a display device accessible by the machine; and
a module operable to obtain predetermined parameters, associate the predetermined parameters with a creation script file, execute the creation script file to install the complete runtime environment according to the predetermined parameters, and publish, on the display device, notification of the installation of the complete runtime environment on the machine.

9. The system according to claim 8, wherein the complete runtime environment is a Solaris container.

10. The system according to claim 9, wherein the predetermined parameters comprise at least one of zone name, IPaddress, Solaris version, number of CPUs, amount of memory and number of processors.

11. The system according to claim 8, wherein the module employs a graphical user interface to obtain the predetermined parameters.

12. The system according to claim 8, the module further operable to determine whether the runtime environment exists on the machine, and to reinstall the runtime environment on the machine when the runtime environment exists.

13. The system according to claim 12, the module further operable to notify a system operator when the runtime environment exists.

14. A computer readable storage medium storing a program of instructions executable by a computer to perform a method for creating a complete runtime environment on a machine, comprising:
obtaining predetermined parameters;
associating, using a processor, the predetermined parameters with a creation script file;
executing, using the processor, the creation script file to install the complete runtime environment according to the predetermined parameters; and
publishing, on a display, notification of the installation of the complete runtime environment on the machine.

15. The computer readable storage medium according to claim 1, wherein the step of executing the creation script file is performing an autoboot.

16. The computer readable storage medium according to claim 1, wherein the complete runtime environment is a Solaris container.

17. The computer readable storage medium according to claim 16, wherein the predetermined parameters comprise at least one of zone name, IP address, Solaris version, number of CPUs, amount of memory and number of processors.

18. The computer readable storage medium according to claim 1, wherein the step of obtaining is performed using a graphical user interface.

19. The computer readable storage medium according to claim 1, further comprising steps of:
determining whether the runtime environment exists on the machine; and
reinstalling the runtime environment on the machine when the runtime environment exists.

20. The computer readable storage medium according to claim 19, further comprising a step of notifying a system operator when the runtime environment exists.
